(19) United States
(12) Patent Application Publication
(10) Pub. No.: US 2006/0293987 A1
(43) Pub. Date: Dec. 28, 2006

(54) Methods and systems for originating and scoring a financial instrument

(76) Inventor: Shapiro, (US)

Correspondence Address: Daniel H. Golub, 1701 Market Street, Philadelphia, PA, 19103, US

(21) Appl. No.: 11/329,502

(22) Filed: Jan. 11, 2006

Related U.S. Application Data
(60) Provisional application No. 60/643,515, filed on Jan. 12, 2005.

(51) Int. Cl. G06Q 40/00

(52) U.S. Cl. 705/35; 705/38

(57) ABSTRACT

A financial instrument exchanged between an owner of real estate and a source of capital. A request for a cash payment is received from the owner. The cash payment is disbursed by the source of capital to the owner. The financial instrument is originated from the owner to the source of capital. The cash payment comprises an amount equal to a percentage of a value of the property measured upon the origination of the financial instrument. The financial instrument comprises an obligation of the owner to pay to the source of capital, at a time associated with a triggering event, a single payment in an amount equal to a percentage of a value of the real estate (including any amounts encumbered by any lien and any amounts unencumbered by any lien) measured at the time associated with the triggering event. The amount of the single payment may be less than the amount of the cash payment.

This application claims priority to U.S. Provisional Patent Application No. 60/643,515, filed Jan. 12, 2005, which is hereby incorporated by reference in its entirety.

### FIELD OF THE INVENTION

The present invention relates to methods and systems for originating and scoring financial instruments.

### BACKGROUND OF THE INVENTION

Currently, there are over one hundred million owner-occupied and rental homes in the United States, with trillions of dollars in lien-free equity (i.e., over and above mortgage amounts). This equity essentially lies dormant, in part because the prior art offers no financial instrument that allows the homeowner to easily leverage this asset without incurring either cash flow from debt repayment (as with home equity loans) or loss of principal on unfavorable terms (as with reverse mortgages). Such equity, if tapped, could provide a source of funding for a variety of different types of investments, thereby achieving greater diversification in the homeowner's investment portfolio, or could provide a source of income for retirees.

Thus, there is a need for an investment vehicle to address the needs of homeowners who have an excessive or disproportionate amount of their net worth in their home equity, and who may be under-serving their retirement or other long-term financial goals.

### SUMMARY OF THE INVENTION

The present invention is directed to a financial instrument and a method for conducting an exchange between an owner of real estate and a source of capital involving the financial instrument. A request for a cash payment is received from the owner. The cash payment is disbursed by the source of capital to the owner. The financial instrument is originated from the owner to the source of capital. The cash payment comprises an amount equal to a percentage of a value of the property measured upon the origination of the financial instrument. The financial instrument comprises an obligation of the owner to pay to the source of capital, at a time associated with a triggering event, a single payment in an amount equal to a percentage of a value of the real estate (including any amounts encumbered by any lien and any amounts unencumbered by any lien) measured at the time associated with the triggering event. The amount of the single payment may be less than the amount of the cash payment.

The present invention is also directed to a system, method and computer-readable medium for determining a risk associated with one or more financial instruments issued by a source of capital. Each financial instrument is associated with one of a plurality of real estate properties, some which are located in a plurality of different geographic regions. One or more scores associated with each of the financial instruments are calculated. The score is based on a weighted average of values associated with a plurality of characteristics. The characteristics include real estate property owner characteristics, real estate property characteristics, and current market conditions in each of the different geographic regions. Certain of the values associated with a likelihood that values of the real estate properties will increase and certain of the values associated with a timing of payment to the source of capital under the financial instrument are weighted more heavily than other of the values. The risk is evaluated based on the scores.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 illustrates the basic components of an exchange between a real estate property owner and a source of capital in accordance with the present invention;

FIG. 2 illustrates a preferred embodiment of a system for carrying out the methods of the present invention;

FIGS. 3A and 3B are a flow chart illustrating a preferred embodiment of a method for originating a financial instrument in accordance with the present invention;

FIG. 3C illustrates the flow of data that occurs in connection with the origination of a financial instrument in accordance with a preferred embodiment of the present invention;

FIG. 3D is a flow chart illustrating a preferred embodiment of a method for subordinating a financial instrument in accordance with a preferred embodiment of the present invention;

FIG. 3E is a flow chart illustrating a preferred embodiment of a method for terminating a financial instrument in accordance with a preferred embodiment of the present invention;

FIG. 4 is an exemplary report issued in connection with a preferred embodiment of the present invention;

FIGS. 5A, 5B, and 5C illustrate an example of calculating a score in connection with a preferred embodiment of the present invention; and

FIG. 6 is a flow chart illustrating a preferred embodiment of a method for determining risk associated with a financial instrument in accordance with a preferred embodiment of the present invention.

### DETAILED DESCRIPTION OF THE PREFERRED EMBODIMENTS

The financial instrument of the present invention (also referred to herein as a “note”) addresses the needs associated with financing a real estate transaction, e.g. purchasing a home or liquidating a portion of the equity in an existing home, e.g., real estate owners who have a disproportionate or excessive amount of net worth in their home equity. In connection with this instrument, a current or prospective real estate property owner can take a portion of his or her home value and, effectively, exchange an interest in some or all of that portion of the home for cash. The proceeds can be used as a financing source for the purchase of the home. Alternatively, or in addition, the proceeds may be used for income or invested to achieve portfolio diversification, or savings related to retirement or education. Proceeds may also be used to pay off or reduce a first mortgage, or may used in combination with a first mortgage on a newly-purchased property to reduce the homebuyer's monthly mortgage obligation. If the proceeds are invested for an agreed to time period, the recipient custodian of those funds may arrange to pay some or all of the transaction costs for originating the financial instrument. In some embodiments, the manner in which the proceeds may be used/invested may be restricted (i.e., by contract) in exchange for subsidizing origination fees and/or providing favorable terms.

The portion of the home value used to create the financial instrument is funded by a source of capital, which will likely be a third party lender or, potentially, the beneficiary of the investment, such as an insurance company, mutual fund company or stock exchange member firm, by way of example. The source of capital then has a security interest in a defined portion of the total property value (including both the unencumbered portion of such value and any portion of such value encumbered by any lien) measured at the time the note matures. The note matures upon the occurrence of a triggering event. The triggering event may be the sale of the property, the death of the property owner, a bankruptcy or insolvency of the property owner, a contractually agreed-upon note expiration, and/or a change in the percentage equity ownership of the property owner as compared to the source of capital. Other triggering events will be known to those skilled in the art and are within the scope of the present invention.

In connection with the inventive financial instrument, the buyer of the instrument (i.e., the source of capital) pays today for the right to receive a defined percentage of the value of the property measured upon the occurrence of the triggering event. However, the instrument also has the option-like behavior in that it can be executed (by way of the property owner selling the property) at any time during the defined life of the note. Unlike other instruments, such as home equity loans or reverse mortgages, the financial instrument of the present invention may eliminate the cash flow issues that come with debt servicing.

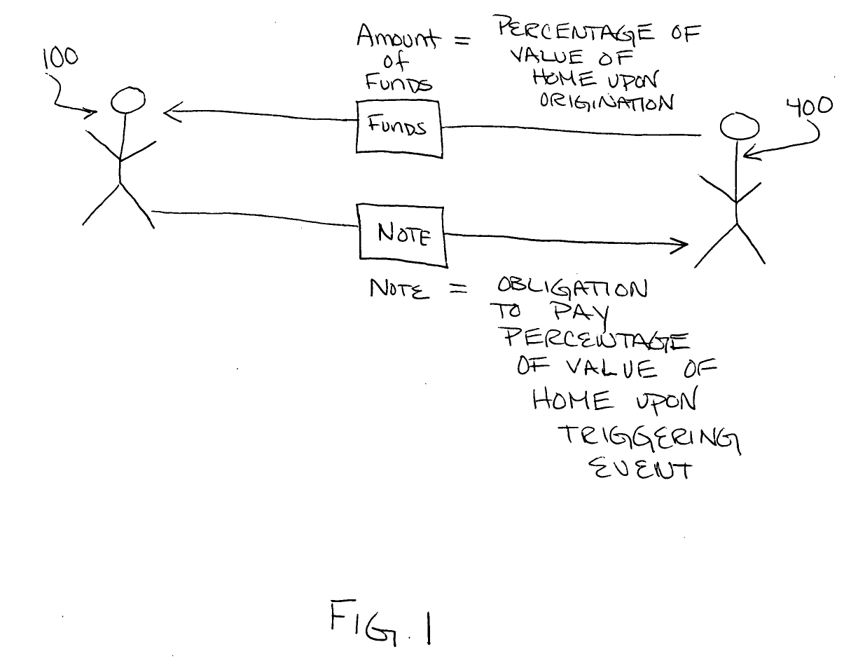

Referring to FIG. 1, a request for a cash payment is received by the source of capital 400 from the owner 100. The cash payment is disbursed by the source of capital 400 to the owner 100. The note is originated from the owner 100 to the source of capital 400. The cash payment comprises an amount equal to a percentage of a value of the property measured upon the origination of the financial instrument. The financial instrument comprises an obligation of the owner to pay to the source of capital, at a time associated with a triggering event, a single payment in an amount equal to a percentage of a value of the real estate (including any amounts encumbered by any lien and any amounts unencumbered by any lien) measured at the time associated with the triggering event. The amount of the single payment may be less than the amount of the cash payment. The triggering event may be a death of the owner; a sale of the real estate; an insolvency proceeding involving the owner; and/or a relative change in a percentage of equity ownership of the source of capital as compared to the owner. In the preferred embodiment, the obligation of the owner is a recourse obligation.

Consider the following example, with reference to Table 1, of how a real estate property owner may take advantage of the inventive financial instrument.

TABLE 1

| | Stage One | Stage Two | Stage Three | State Four |
|---|---|---|---|---|
| | Purchase Mortgage | Home Equity Line | Financial Instrument | Home Sale |
| Date | 1990 | 1995 | 2005 | 2020 |
| Value | $500,000 | $650,000 | $1,000,000 | $2,000,000 |
| New Encumbrance | $400,000 | $100,000 | $200,000 | 0 |
| Total Encumbrance | $400,000 | $500,000 | $700,000 | $1,100,000 |
| Home Equity | $100,000 | $150,000 | $300,000 | $900,000 |
| Retirement Account | 0 | 0 | $200,000 | $500,000 |
| Total Value | $100,000 | $150,000 | $500,000 | $1,400,000 |

In this example, in 2005, the source of capital pays to the property owner $200,000 in exchange for a note representing a twenty percent stake in the property. The property owner invests the $200,000 (i.e., in the owner's retirement account). Upon the sale of the property in 2020, the source of capital is entitled to a payment of $400,000 (i.e., 20% of the total value of the home). If, in this example, the value of the property decreased to $500,000 in 2020 (instead of increasing to $2,000,000), then the source of capital would only be entitled to a payment of $100,000 (i.e., 20% of the total value of the home), which is less than the cash disbursement made to the property owner.

An exemplary note that may be issued to the source of capital by the real estate property owner is provided in Appendix A. The transaction resulting in the issuance of the note can occur in connection with the purchase of a property, or at a later time.

An exemplary lifecycle of the financial instrument of the present invention can be described as follows. The cycle begins when a real estate property owner is compelled to redeploy a portion of his property by originating a note with a source of capital. Once the note is originated and the disbursement of funds is complete, the note may either be held by the source of capital as an asset or placed into the secondary market for resale to investors or other aggregators, such as a pension fund and other institutional investor, mutual funds or REITs. During its time in the secondary market, when the note may be held in a portfolio or actively traded, the note may be serviced, including pricing and scoring of the note and the underlying property, and continued monitoring of the lien state of the property and other periodically changing parameters. The servicing cycle may continue for months or years, until a triggering event occurs, which may be the sale of the property, expiration of the note (if such an expiry is included in its terms), voluntary settlement (buyback) of the note by the homeowner, and/or other events. At the time of note termination, an appraisal may be performed. The monetary value resulting from the appraisal may be used in the course of negotiating the property sale (if applicable) and to determine how the proceeds of the sale are distributed between the note holder and the homeowner, as well as any other lien holders senior and subordinate to the note holder. Once the terms of the note termination are finalized, the associated numbers are used to generate a retrospective performance report for the note.

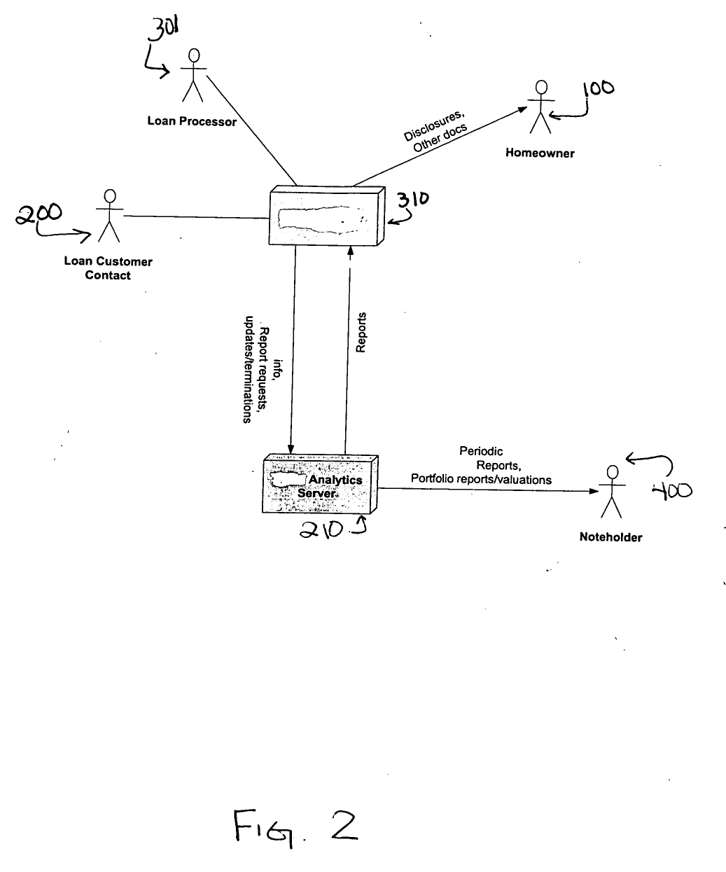

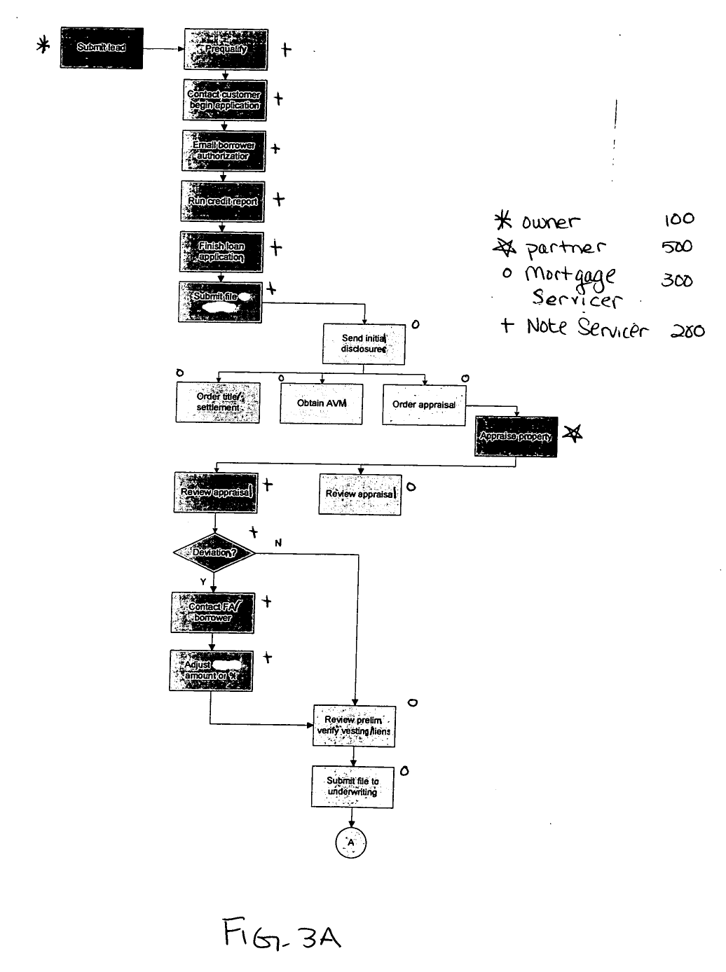

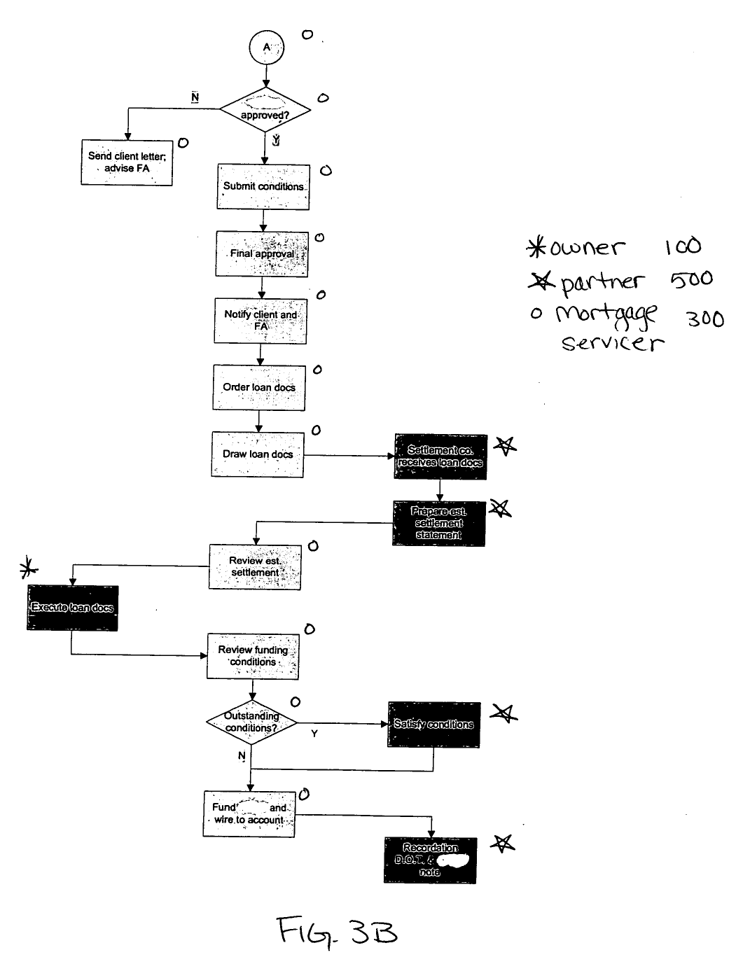

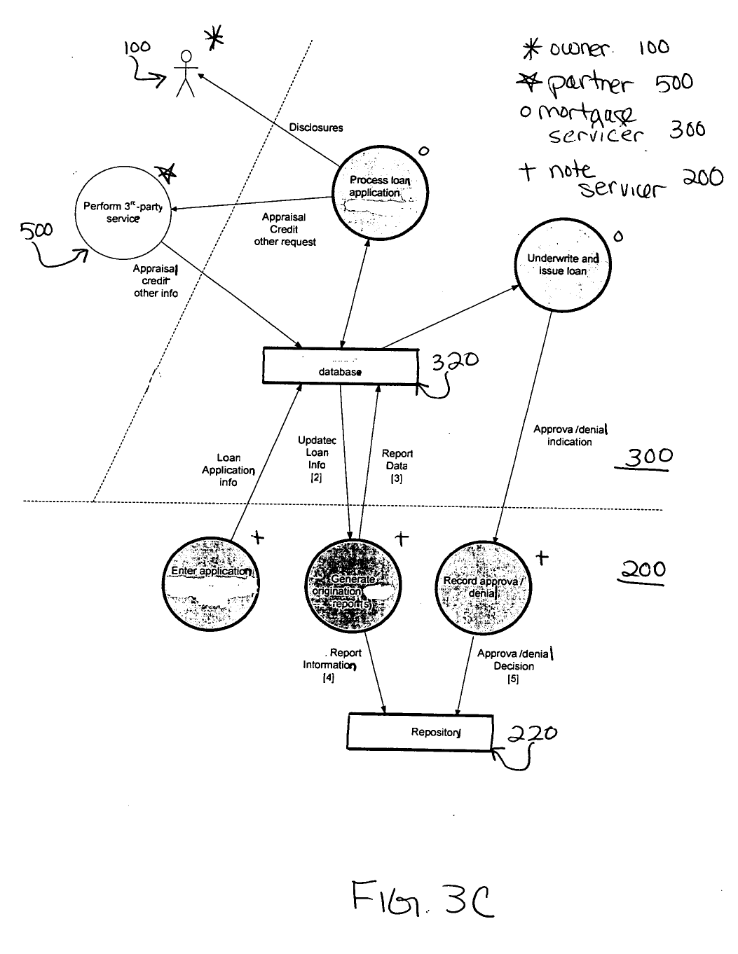

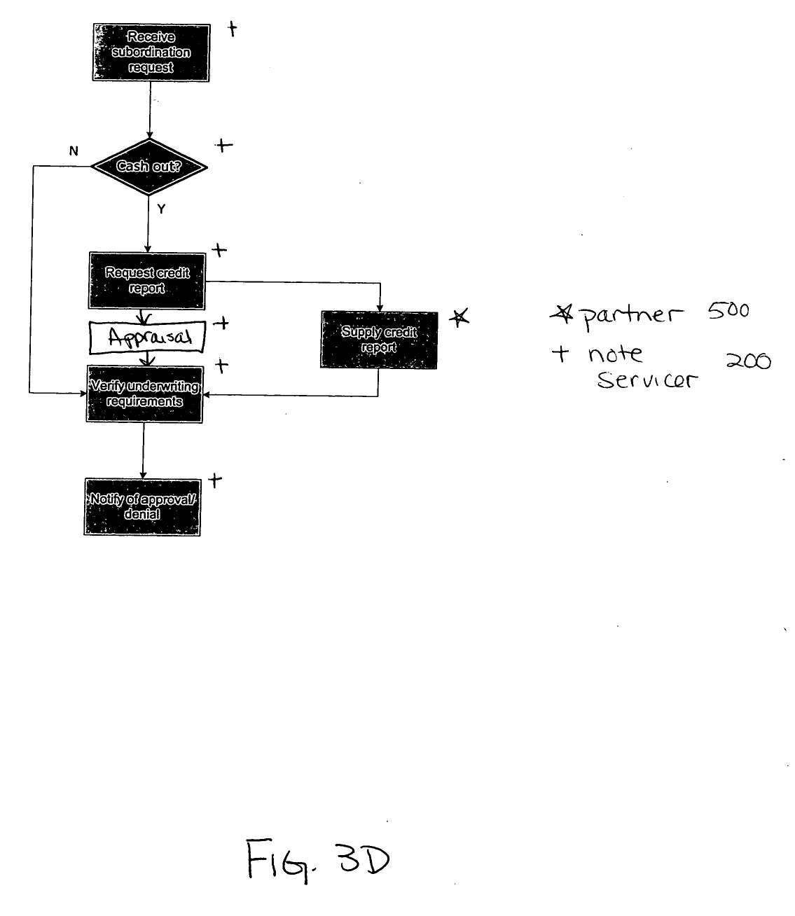

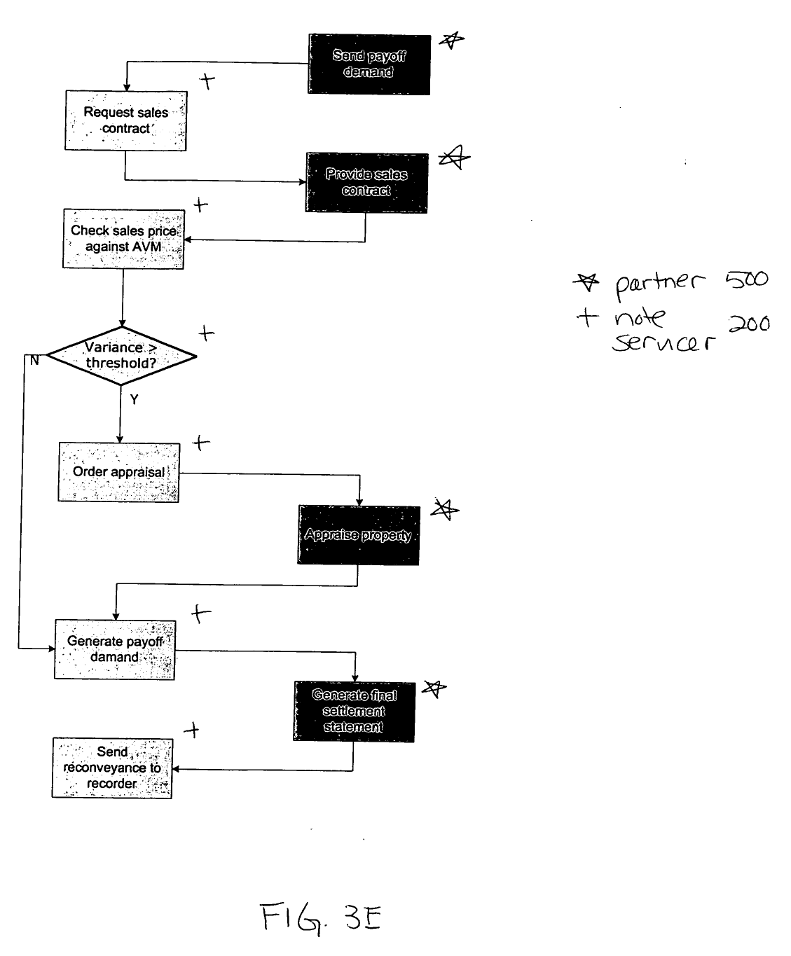

A detailed description of the system for carrying out the present invention, and exemplary workflows associated with such processes follows, with reference to FIGS. 2, 3A, 3B, 3C, 3D and 3E.

With reference to FIG. 2, a block diagram illustrating an exemplary system for carrying out the present invention is shown. A real estate property owner 100 may communicate with a note servicer 200 to initiate the process. Server 310 is used to maintain and process the information provided by the owner 100 in connection with originating the note. Server 310 also receives requests for reports, information updates and note terminations. Loan processor 301 assists with the preparation and processing of the documentation used in connection with the origination of the note. Analytics server 210 provides the engine for generating reports, including scores for the notes originated using the inventive system, as discussed in more detail below. Source of capital 400 receives the note in exchange for providing the funds the real estate property owner 100. All or a portion of the communications between the entities in the inventive system may be conducted over a LAN or WAN, such as the internet, using HTTP/SSL or secure FTP.

FIGS. 3A and 3B comprise a flow chart, illustrating exemplary steps involved in originating a note in accordance with one embodiment of the present invention. FIG. 3C is a diagram illustrating an exemplary flow of data in connection with origination of a note in accordance with one embodiment of the present invention. Each block (representing a step) in the flow chart and each component in the data flow diagram is symbol coded to indicate which party performs the particular step or is responsible for maintaining the particular component, although it will be recognized by those skilled in the art that such steps may be performed, and components maintained, by different entities involved in the process, within the scope of the present invention.

With reference to FIG. 3A, a real estate property owner 100 (or a financial advisor on his behalf) makes a request to commence the process. The note servicer 200 performs an initial analysis to determine if the owner 100 is qualified to apply. The application process is commenced, which includes the running of a credit report, and the sending of an authorization that the mortgage servicer 300 may communicate status information to the financial advisor. Upon completion of the loan application, the file is submitted to the mortgage servicer 300. Mortgage servicer 300 sends initial disclosure information to server 310 for delivery to the consumer, orders a title search and an appraisal, and runs an Automated Valuation Model (AVM). A third party service provider 500 conducts an appraisal of the property. The appraisal is reviewed by both the mortgage servicer 300 and the note servicer 200. The note servicer 200 determines whether there is any out of parameter deviation between the AVM and the appraisal that requires reconciliation prior to an offer being made by the mortgage servicer 300. If not, the mortgage servicer 300 reviews any liens on the property and submits the file to underwriting. If there is deviation, the note servicer 200 contacts the owner 100 or his financial advisor to discuss and the amount of funds requested by the owner will be adjusted to account for the deviation. Upon such adjustment, the process then continues as in the event of no deviation. The underwriting process is described in more detail below.

Continuing with the origination workflow with reference to FIG. 3B, the mortgage servicer 300 determines whether the note is approved by underwriting. If not, the owner 100 or his financial advisor is informed of the same. If approved, the conditions of the approval are submitted, final approval is made, and the owner 100 is informed. Loan documents are ordered and drawn. A third party service provider 500 (such as a settlement company) receives the loan documents and prepares an estimated settlement statement. The mortgage servicer 300 receives and reviews the estimated settlement statement. The owner 100 executes the loan documents and provides them to the mortgage servicer 300. The mortgage servicer 300 reviews the documents to determine if any funding conditions remain outstanding. If so, such conditions are satisfied by third party service provider 500. The note is then funded by the mortgage servicer 300 and wired to the account of the owner 100. Third party service provider 500 records the note to complete the origination process.

With reference to FIG. 3C, the flow of data between the various entities is illustrated. Database 320 maintains information regarding the loan application and the note data. Repository 220, discussed in more detail below, maintains all data relating to the note to enable historical reporting and analysis.

With reference to FIG. 3D, a flow chart for subordination of the note is shown. Each block (representing a step) in the flow chart is symbol coded to indicate which party performs the particular step, although it will be recognized by those skilled in the art that such steps may be performed by different entities involved in the process, within the scope of the present invention. This process is different from ordinary loan subordination, given that a reassessment of loan-to-value and, possibly, a new appraisal are involved to ensure that the underwriting metrics of the note are not violated.

The process involved with termination of the note, illustrated with reference to the flow chart of FIG. 3E, is also different from an ordinary loan termination, as the payoff amount is not predetermined and must be assessed in accordance with the terms of the note, including verification of the arms-length nature of the transaction, and any difference between the sale price and any benchmark valuation. Each block (representing a step) in the flow chart is symbol coded to indicate which party performs the particular step, although it will be recognized by those skilled in the art that such steps may be performed by different entities involved in the process, within the scope of the present invention.

As the present invention provides a new type of financial instrument, sources of capital/note holders will need a way to establish underwriting guidelines. These guidelines are used to determine if the real estate property owner qualifies to take part in the exchange and what fee will be charged. In a typical debt mortgage situation, the items principally considered are the FICO score, credit history, employment history of the property owner and a comparison of the loan amount to the value of the property. In contrast, for the financial instrument of the present invention, several other factors will have an impact on the anticipated return; thus, taking into account appropriate factors in connection with the underwriting is very important.

The two primary metrics for establishing value for the source of capital/note holder are the anticipated return and the length of time the source of capital/note holder will need to wait to realize the return. Some factors are relative to both issues, as they indicate how the property might perform with respect to appreciation and provide insight as to how long the property will be held before a terminating event. Therefore, underwriting guidelines focus on the following factors, in the preferred embodiment. Not all of these factors need be used and, indeed, additional factors may be used within the scope of the present invention.

Anticipated Return Factors
Comparison of property characteristics to Metropolitan Service Area (“MSA”) (or more finite) averages
Future growth rate metrics
Anticipated job growth for the area
Anticipated population growth for the area
Current value relative to the area
Age of real estate
Number of bedrooms
Number of bathrooms
Lot size
Condition of the real estate property
Comparison of the note amount to the owner's equity

Duration Risk Factors
Age of real estate property owner
Age of real estate property
Number of bedrooms
Number of bathrooms
Lot size
Property condition
Loan to owners equity
Credit score
Employment history

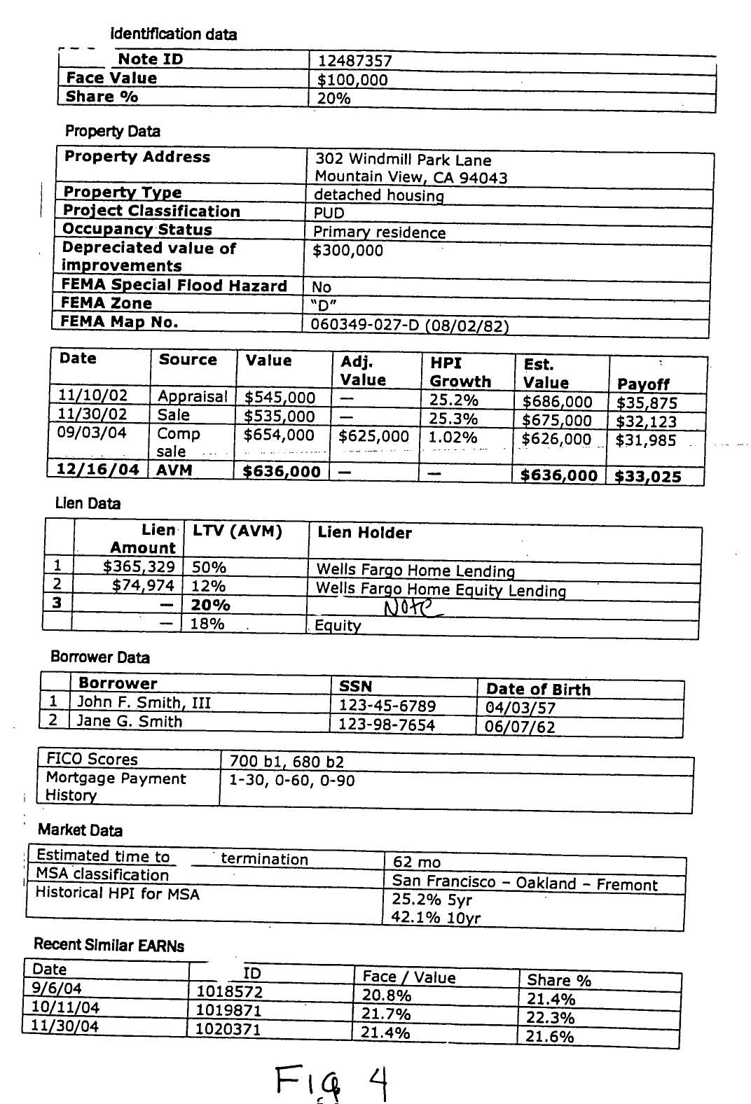

Various aspects of the present invention result a need for the issuance of reports. An exemplary report is shown in FIG. 4. The report may incorporate both fundamental (i.e., factual) data about the note and the associated property, as well as analytical assessments/projections of risk and future return.

During the life of a note issued in connection with the present invention, information is gathered and updated to reflect the status of the note, which may be delivered to authorized, interested parties in the report. In the preferred embodiment, the report includes real estate property owner information, real estate property information, and related real estate market data. The real estate property owner information may incorporate credit and other economic information useful to determine (underwrite) the terms of the note, and to understand and project the homeowner's probability of selling the property and terminating the note. The property information may include an enhanced appraisal (including geocentric information and property condition relative to local comps), and title and insurance information. Market information includes data that quantifies and classifies the specific area (e.g., within a narrow band such as an MSA, or a radius around the property's geocoded location), so that scoring of the specific property (see below discussion) can be performed in relation to local, regional and national markets. In addition to the core data, the report may also include benchmark scoring and stochastic information that provides the ability to assess comparative risk and value for the specific note. These benchmarks may be used as the baseline against which other pricing and risk assessment models are compared.

Such reports may be used by a number of different interested individuals, as follows. The real estate property owner may ask that such are report be prepared for his property to assist him in determining the terms and viability of entering into a transaction resulting in a note being issued. Lending institutions that capitalized on such notes may use the report to determine the terms and conditions of the note that they are willing to offer. Portfolio managers may use the reports to assess and identify properties they want to hold or trade. Note holders may use the report to assess and identify the status, value and condition of their holdings in order to track portfolio value and also to afford them the opportunity to take action in the event the property becomes distressed. They also use the valuation in a current report at the time of property sale (or other triggering event) to determine fair market value and any economic contingencies that may be triggered by the sale (e.g., a sale far below fair market value). Traders/market makers may use the benchmark stochastics in the reports to assess risk and pricing in the trading market.

The financial instrument creates a consistent “wrapper” around a defined portion of the equity in a real estate property, using the scoring techniques described herein. Because of the consistency imparted by this approach, the inventive financial instruments can be readily securitized and traded in secondary markets, as reference above. They can be equally well be aggregated into block portfolios, investment pools, exchange traded funds, mutual funds, or REITs.

One exemplary approach to producing an objective, quantitative assessment of a given property's risk and appreciation potential involves the calculation of one or more benchmark scores—in one embodiment, a return risk score (RS) and a property investment quality score (IQ). These scores may be computed as sum of weighted factors, as in the following two equations:
RS=rw1*rf1+rw2*rf2+rw3*rf3+
IQ=iw1*if1+iw2*if2+iw3*if3+
where rw=return risk weight

rf=return risk factor

iw=investment quality weight

if=investment quality factor

In other embodiments, a single score (and, thus, a single equation) may be used. In a preferred embodiment, the weights are real numbers, positive or negative, and factors may be normalized to a scalar range (e.g., from 0-100) in advance to allow simple summation in this computation. Thus, the score(s) calculated in connection with the present invention is a quantitative measure of the potential future appreciation of an individual property or pooled properties. The score takes into account a number of factors that bear on when the triggering event will occur (e.g., when the owner of the real estate property is likely to sell the real estate or die) and what the value of the property will be upon the occurrence of the triggering event.

Such factors include characteristics of the real estate property owner, characteristics of the real estate property, and market conditions. The characteristics of the real estate property owner include a credit score, employment history, and/or age. The characteristics of the real estate property include the value and age (as of the date of the origination of the financial instrument), the number of bedrooms, number of bathrooms, lot size, and/or property condition. Market conditions include property characteristics, such as those identified previously, to MSA (or more finite) averages; future growth rate metrics; anticipated job growth for the area in which the real estate property is located; and/or anticipated population growth for the area in which the real estate property is located. Certain of these listed factors are not relevant in connection with analyzing a traditional debt mortgage, but are very important to analysis of the financial instrument of the present invention. Further, to the extent some of these factors are used in connection with a traditional debt mortgage, such factors are weighted differently in connection with analyzing the financial instrument of the present invention.

By way of example, with respect to characteristics of the real estate property owner, the age of the owner is the most important factor; the credit score is the second most important factor; and the employment history is only minor factor. With regard to a traditional debt mortgage, age of the owner is typically not used; the credit score is the most important factor; and the employment history of the owner is relatively important. By way of further example, with respect to characteristics of the real estate property, the value of the property upon origination and property condition are the most important factors considered in connection with analyzing the financial instrument of the present invention, with age of property, number of bedrooms/bathrooms and lot size being of next greatest importance. All of these factors are either insignificant or not used in connection with the analysis of a traditional debt mortgage. With respect to market conditions, a comparison of the characteristics of the real estate property to MSA averages, future growth rate metrics, and anticipated job growth for the area are very important, whereas such factors are not even considered in analyzing a traditional debt mortgage.

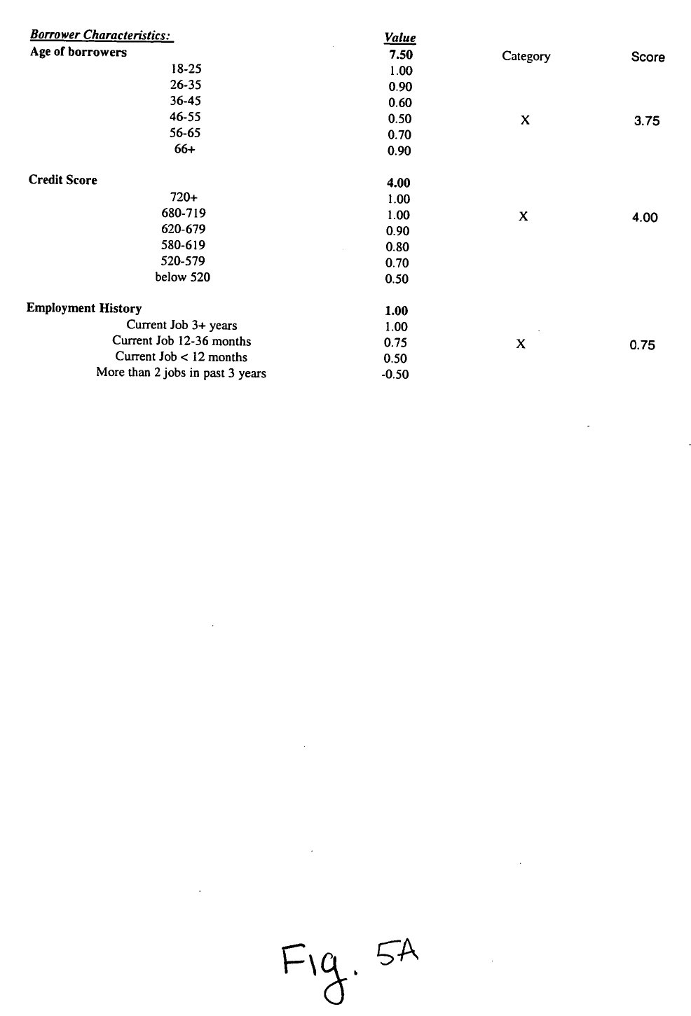

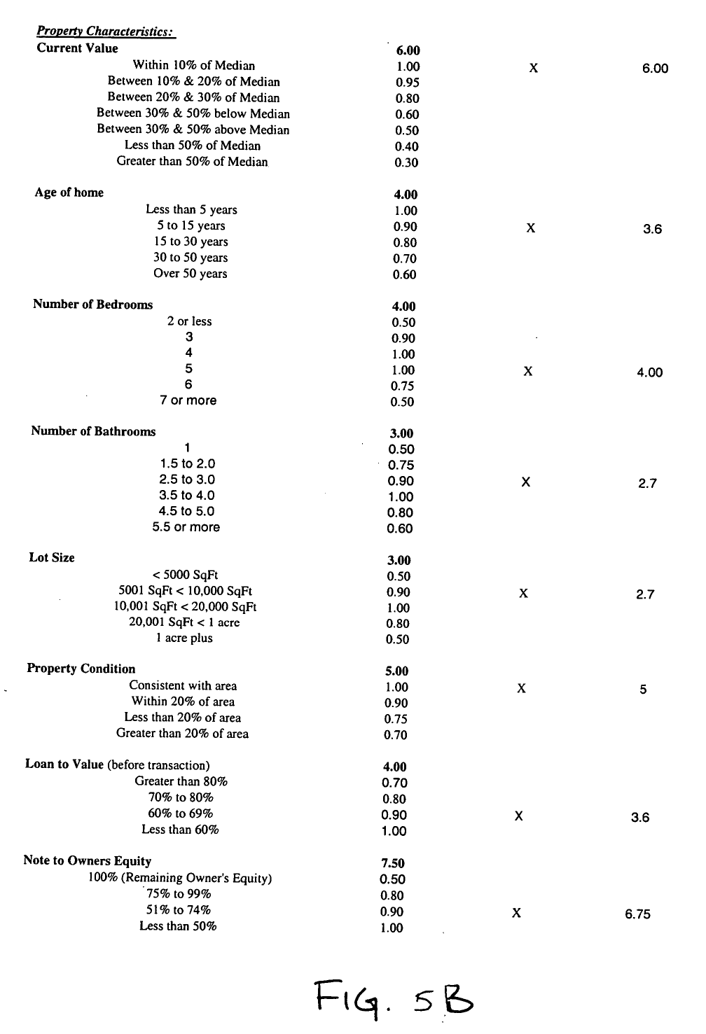

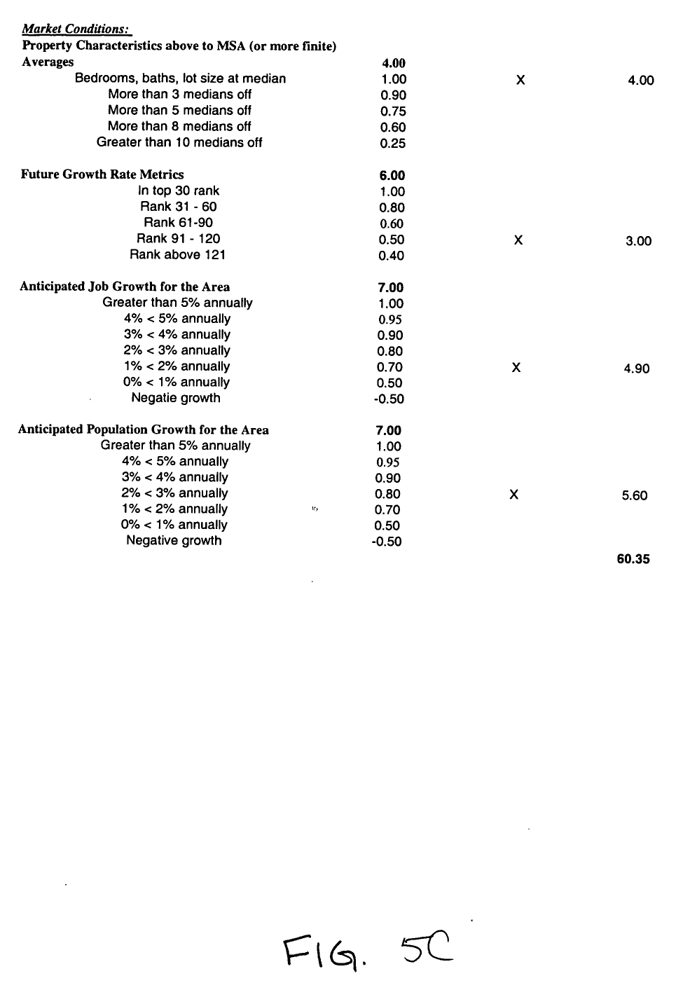

An example of the manner in which the score may be calculated for a given property is illustrated with reference to FIGS. 5A, 5B and 5C. As shown, each characteristic is assigned a value, and the different categories for each characteristic are assigned a weight. The sum of the various weights (for the particular category attributable to the property/owner in question) multiplied by the values for each characteristic will result in a score.

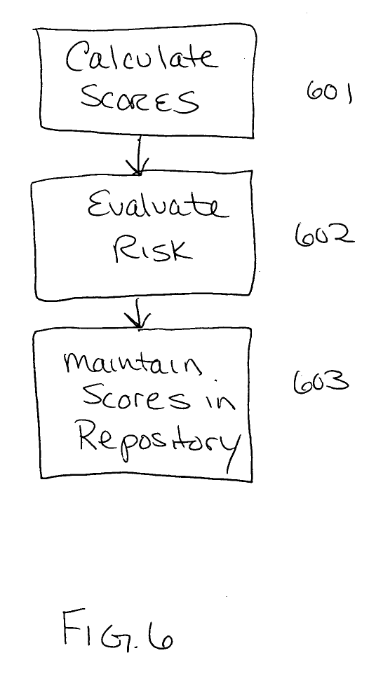

FIG. 6 is a flow chart illustrating a method for determining risk associated with one or more financial instruments issued by a source of capital, wherein each financial instrument is associated with one of a plurality of real estate properties and wherein some of the real estate properties are located in a plurality of different geographic regions. The method may be carried out by software. In step 601, one or more scores associated with each of the financial instruments are calculated. The score is based on a weighted average of values associated with a plurality of characteristics, the characteristics comprising real estate property owner characteristics, real estate property characteristics, and current market conditions in each of the different geographic regions. Certain of the values associated with a likelihood that values of the real estate properties will increase and certain of the values associated with a timing of payment to the source of capital under the financial instrument are weighted more heavily than other of the values. In step 602, the risk is evaluated based on the scores. In some embodiments, the real estate property owner characteristics comprise one or more of a credit score, an employment history and an owner age; the real estate property characteristics comprise one or more of a current value, a real estate property age, a number of bedrooms, a number of bathrooms, a lot size, and a real estate property condition; and the current market conditions comprise one or more of a comparison of one or more of the real estate property characteristics to average real estate property characteristics in a metropolitan statistical area, future growth rate metrics, anticipated job growth, and anticipated population growth.

The determination of the risk may be performed in connection with underwriting one or more of the financial instruments. The determination of the risk may also be performed in connection with trading one or more of the equity mortgages in a secondary market.

In some embodiments, in step 603, the scores are maintained in a data repository, as discussed in more detail below. In such embodiments, a plurality of the financial instruments may be grouped into a pool and, in this case, the scores for the pool of equity mortgages are associated in the data repository.

In order to support the requirements associated with managing the note as a securitized, tradable instrument, and with its eventual termination, a data repository may be created and maintained (for example, repository 220 of FIG. 3C). The data repository will store historical and current data relating both to the origination of the notes and the macro and micro economic conditions that effect the ongoing value of pools of the instruments as well as estimates as to the value of each individual instrument. Data elements, such as those discussed herein used in connection with underwriting, represent at least some of the those that may be included. Maintaining a database of this sort will allow investors to create categories of notes based on factors expected to affect performance and risk, thereby allowing such investors to make predictions as to the returns of notes they may be considering for purchase or origination. Searches of the database can be performed for characteristics that have historically differentiated the returns of one property from another. A set of factors that are inclusive, but not redundant, can be developed, from which a portfolio of indices can be built that assist the investor compare these real estate indices to investments in other classes. Also, to the extent certain of the notes are grouped into a pool, such pooled notes are associated by way of the data repository.

The present invention presents new market opportunities. For example, the National Association of Securities Dealers in the past issued a formal alert (04-89) indicating that financial planners should not make recommendations to real estate property owners to diversify their portfolio by taking out a home equity loan and using the proceeds thereof to purchase alternative investments (e.g., stocks, bonds, and other savings/investment vehicles), as such activity could result in the property owner losing his home. Because the inventive financial instrument is not a debt instrument (and, thus, cannot result in the property owner losing his home), using this as a financial planning tool is a viable alternative.

In addition, new home builders may find great value in being able to offer their homes at a lower monthly cost by combining a financial instrument of the present invention with the original financing. The packaging of financial instruments issued in this way for the secondary market may be relatively simple, due to the relative similarity of the properties.

The present invention is intended to embrace all alternatives, modifications and variances that fall within the scope of the appended claims.

### Appendix A

### Note

[Date] [City] [State]

### Property Address

1. Borrower's Promise to Pay

In return for disbursement to the undersigned (or for the account of the undersigned) of the sum of U.S.$ ______, receipt of which is hereby acknowledged, I promise to pay to the order of ______ the sum equal to ______ percent (______%) of the first $______ of the Fair Market Value (as defined below) of the Property (as defined below) at the time of a Payment Event (as defined below) plus ______ percent (______%) of the Fair Market Value of the Property at the time of a Payment Event in excess of $______. I will make all payments under this Note in the form of cash, check or money order.

I understand that ______ may transfer this Note. ______ or anyone who takes this Note by transfer and who is entitled to receive payments under this Note is called the “Note Holder.” At all times, the Note Holder will be represented under this Note by its agent EARN, Inc., having an address of 1901 S. Bascom Avenue, #200, Campbell, Calif. 95008.

I will pay directly to the servicing agent designated by the Note Holder the sum of $______ per year (“Annual Fees”), payable on the anniversary date of this Note, for the cost of maintaining this Note and the administration of it.

2. The Property and Fair Market Value

The “Property” is that real property located at ______, which is subject to a Security Instrument for the benefit of the Note Holder, and is legally described in that Security Instrument.

The “Fair Market Value” of the Property will be determined by reference to the value, if any, for the Property indicated in the applicable Payment Event, and the Fair Market Value will be estimated from time to time generally by the automated value model, as that model may be adjusted from time to time as disclosed in the periodic statements showing the Fair Market Value calculated using this model, distributed from time to time to me by Note Holder's agent, EARN Inc.; provided that EARN Inc. may determine the fair market value of the Property by using a formal appraisal if the value of the Property indicated in the Payment Event is either less or more than the automated value model value by more than ______ percent. The Fair Market Value is at all times determined without deduction for any costs of sale, other transaction costs, or other costs of the Payment Event.

A “Payment Event” is the first to occur of the following events:
1. A Prepayment, as defined in Section 5 below.
2. Any sale, conveyance, lease for a term of more than sixty days in any calendar year, encumbrance in a principal amount greater than [seventy percent (70%)] of the Fair Market Value of the Property, or other divestiture of title of the Property, whether voluntarily or involuntarily [, without the written consent of Note Holder being first had and obtained].
3. A breach of any of my obligations under the Security Instrument, which is not cured within ______ days of my receipt of notice of that breach from the Note Holder.
4. Any bankruptcy, insolvency, conservatorship, receivership, or liquidation proceeding or other proceeding for relief under any bankruptcy law or any law for the relief of debtors is instituted by or against me.
5. My death, provided that if there are two persons signing this Note, then the Payment Event will occur on the date of death of the second person to die.

“Security Instrument” means a Mortgage, Deed of Trust, or Security Deed, dated the same date as this Note, which imposes a lien on the Property to secure the performance of my obligations under this Note.

3. Payments

Payment under this Note will be due and payable in cash on each anniversary date of this Note, as to the Annual Fees, and on the occurrence of a Payment Event. I may choose to pay a one time fee, instead of an annual fee, if that choice is offered by the Note Holder by separate agreement. With regard to Payment Events that are sales, refinances, or other dispositions of the Property, each such transaction must close through an escrow, and payment shall be made under this Note from escrow for such transaction. I will make my payments to the agent of the Note Holder, EARN, Inc., having an address of 1901 S. Bascom Avenue, #200, Campbell, Calif. 95008, or at a different place if required by EARN, Inc. or the Note Holder.

4. Interest Rate

The amounts due under this Note will not earn interest, except that from the [date an Annual Fee is due and the] date of the Payment Event [in each case] until paid, the amount due under this Note will bear interest at the per annum rate of ______ percent (______%), not to exceed the maximum rate permitted by the applicable law under this Note, if such maximum rate is lower.

5. Borrower's Right to Prepay

I have the right to make payment in full under this Note at any time before it otherwise becomes due, known as a “Prepayment.” When I make a Prepayment, I will tell EARN, Inc., as the Agent of the Note Holder in writing that I am doing so. In making a Prepayment, I will pay the costs of Note Holder in responding to my Prepayment, which will be disclosed to me in response to my notice of intention to make a Prepayment.

6. Costs and Charges

In case an appraisal is required to determine Fair Market Value under this Note, I shall bear the cost of that appraisal, which shall be paid at the same time as the other payments due under this Note, unless the appraised value found in the appraisal is lower than the value of the Property determined by reference to the automated value model, by more than ______ percent.

7. Borrower's Failure to Pay as Required

(A) Default

If I do not pay the any amounts due under this Note on the dates they are due, I will be in default.

(B) Notice of Default

If I am in default, the Note Holder may send me a written notice telling me that if I do not pay the overdue amount by a certain date, the Note Holder may take action to enforce its obligations, including a foreclosure on the property securing this Note, in accordance with applicable law.

(C) No Waiver By Note Holder

Even if, at a time when I am in default, the Note Holder does not require me to pay immediately in full as described above, the Note Holder will still have the right to do so if I am in default at a later time.

(D) Payment of Note Holder's Costs and Expenses

If the Note Holder has required me to pay immediately in full as described above, the Note Holder will have the right to be paid back by me for all of its costs and expenses in enforcing this Note to the extent not prohibited by applicable law. Those expenses include, for example, reasonable attorneys' fees.

8. Giving of Notices

Unless applicable law requires a different method, any notice that must be given to me under this Note will be given by delivering it or by mailing it by first class mail to me at the Property Address above or at a different address if I give the Note Holder a notice of my different address.

Any notice that must be given to the Note Holder under this Note will be given by delivering it or by mailing it by first class mail to the Note Holder at the address stated in Section 3 above or at a different address if I am given a notice of that different address.

9. Obligations of Persons Under this Note

If more than one person signs this Note, each person is fully and personally obligated to keep all of the promises made in this Note, including the promise to pay the full amount owed. Any person who is a guarantor, surety or endorser of this Note is also obligated to do these things. Any person who takes over these obligations, including the obligations of a guarantor, surety or endorser of this Note, is also obligated to keep all of the promises made in this Note. The Note Holder may enforce its rights under this Note against each person individually or against all of us together. This means that any one of us may be required to pay all of the amounts owed under this Note.

10. Waivers

I and any other person who has obligations under this Note waive the rights of Presentment and Notice of Dishonor. “Presentment” means the right to require the Note Holder to demand payment of amounts due. “Notice of Dishonor” means the right to require the Note Holder to give notice to other persons that amounts due have not been paid.

11. Security Instrument

In addition to the protections given to the Note Holder under this Note, a Security Instrument protects the Note Holder from possible losses which might result if I do not keep the promises which I make in this Note. That Security Instrument describes how and under what conditions I may be required to make immediate payment in full of all amounts I owe under this Note. Some of those conditions are described as follows:
If all or any part of the Property or any Interest in the Property is sold or transferred (or if Borrower is not a natural person and a beneficial interest in Borrower is sold or transferred) without the Note Holder's prior written consent, the Note Holder may require immediate payment in full of all sums secured by this Security Instrument. However, this option shall not be exercised by the Note Holder if such exercise is prohibited by Applicable Law.
   12. Change of Occupancy

If Section 2 of this Note is breached due to a leasing of the Property for a period in excess of 60 days per year, then the Note Holder shall have the right to require payment of this Note under the terms prescribed in this Note, or the Note Holder may, in its discretion, allow the undersigned to offer the Property as a rental property subject to an increase in the amount due and payable at a Payment Event by ______%. WITNESS THE HAND(S) AND SEAL(S) OF THE UNDERSIGNED.
______(Seal)
—Borrower

What is claimed is:

1. A method for conducting an exchange between an owner of real estate and a source of capital, the method comprising:
(A) receiving from the owner a request for a cash payment;
(B) disbursing the cash payment by the source of capital to the owner; and
(C) originating a financial instrument from the owner to the source of capital;
wherein the cash payment comprises an amount equal to a percentage of a value of the property measured upon the origination of the financial instrument; and
wherein the financial instrument comprises an obligation of the owner to pay to the source of capital, at a time associated with a triggering event, a single payment in an amount equal to a percentage of a value of the real estate, the value including any amounts encumbered by any lien and any amounts unencumbered by any lien, measured at the time associated with the triggering event, wherein the amount of the single payment may be less than the amount of the cash payment.

2. The method of claim 1 wherein the amount of the cash payment does not exceed an amount of equity in the real estate measured upon the origination of the financial instrument.

3. The method of claim 1 wherein the triggering event comprises at least one of a death of the owner; a sale of the real estate; an insolvency proceeding involving the owner; and a relative change in a percentage of equity ownership of the source of capital as compared to the owner.

4. The method of claim 1 wherein a recommendation to conduct the exchange is initiated by a financial planner.

5. The method of claim 1 wherein the property comprises a newly constructed home and the source of capital comprises a new home builder.

6. The method of claim 1 wherein the obligation is a recourse obligation.

7. A financial instrument issued by an owner of real estate to a source of capital, comprising:
an obligation from the owner to the source of capital to pay to the source of capital, at a time associated with a triggering event, a single payment in an amount equal to a percentage of a value of the real estate, the value including any amounts encumbered by any lien and any amounts unencumbered by any lien, measured at the time associated with the triggering event,
wherein, in exchange for the obligation, the source of capital disburses to the owner a cash payment comprising an amount equal to a percentage of a value of the property measured upon origination of the financial instrument, and
wherein the amount of the single payment may be less than the amount of the cash payment.

8. A method for determining a risk associated with one or more financial instruments issued by a source of capital, wherein each financial instrument is associated with one of a plurality of real estate properties, wherein some of the real estate properties are located in a plurality of different geographic regions, the method comprising:
(A) calculating one or more scores associated with each of the financial instrument;
wherein the score is based on a weighted average of values associated with a plurality of characteristics, the characteristics comprising real estate property owner characteristics, real estate property characteristics, and current market conditions in each of the different geographic regions; and
wherein certain of the values associated with a likelihood that equity in the real estate properties will increase and certain of the values associated with a timing of payment to the source of capital under the equity mortgage are weighted more heavily than other of the values, and
(B) evaluating the risk based on the scores.

9. The method of claim 8 wherein,
(i) the real estate property owner characteristics comprise one or more of a credit score, an employment history and an owner age;
(ii) the real estate property characteristics comprise one or more of a current value, a real estate property age, a number of bedrooms, a number of bathrooms, a lot size, and a real estate property condition; and
(iii) the current market conditions comprise one or more of (I) a comparison of one or more of the real estate property characteristics to average real estate property characteristics in a metropolitan statistical area, (II) future growth rate metrics, (III) anticipated job growth, and (IV) anticipated population growth.

10. The method of claim 8 wherein the determination of the risk is performed in connection with underwriting one or more of the financial instruments.

11. The method of claim 8 wherein the determination of the risk is performed in connection with trading one or more of the equity mortgages in a secondary market.

12. The method of claim 8 further comprising:
(C) maintaining the scores in a data repository.

13. The method of claim 8 wherein a plurality of the financial instruments are grouped into a pool and wherein the scores for the pool of equity mortgages are associated in the data repository.

14. A computer-readable medium comprising instructions which, when operated on by a computer, cause the computer to determine a risk associated with one or more financial instruments issued by a source of capital, wherein each financial instrument is associated with one of a plurality of real estate properties, wherein some of the real estate properties are located in a plurality of different geographic regions, by:
(A) calculating one or more scores associated with each of the financial instrument;
wherein the score is based on a weighted average of values associated with a plurality of characteristics, the characteristics comprising real estate property owner characteristics, real estate property characteristics, and current market conditions in each of the different geographic regions; and
wherein certain of the values associated with a likelihood that equity in the real estate properties will increase and certain of the values associated with a timing of payment to the source of capital under the equity mortgage are weighted more heavily than other of the values, and
(B) evaluating the risk based on the scores.

15. A system for determining a risk associated with one or more financial instruments issued by a source of capital, wherein each financial instrument is associated with one of a plurality of real estate properties, wherein some of the real estate properties are located in a plurality of different geographic regions, comprising:
one or more servers that calculate one or more scores associated with each of the financial instrument and evaluate the risk based on the scores,
wherein the score is based on a weighted average of values associated with a plurality of characteristics, the characteristics comprising real estate property owner characteristics, real estate property characteristics, and current market conditions in each of the different geographic regions; and
wherein certain of the values associated with a likelihood that equity in the real estate properties will increase and certain of the values associated with a timing of payment to the source of capital under the equity mortgage are weighted more heavily than other of the values.

16. The system of claim 15 further comprising:
a data repository for maintaining the scores.
